(19) United States
(12) Patent Application Publication
(10) Pub. No.: US 2007/0131704 A1
(43) Pub. Date: Jun. 14, 2007

(54) Cigarette dispenser

(76) Inventors: Alberto Ahedo, Carranza (ES); Asier Ugarte, Aretxabaleta (ES)

Correspondence Address: THE KLINE LAW FIRM, P.C., 161Little Pond Lane, Palmyra, VA, 22963-5161, US

(21) Appl. No.: 11/601,151

(22) Filed: Nov. 17, 2006

(30) Foreign Application Priority Data
Dec. 13, 2005 (ES) P 200503059

(51) Int. Cl. G07F 11/00

(52) U.S. Cl. 221/88

(57) ABSTRACT

Cigarette dispenser that comprises a compartment (2) where cigarettes (200) are stored, an opening (11) through which the cigarettes (200) facing said opening (11) are provided, a lid (3) which covers the opening (11) and which is attached to the dispenser (1) by means of a rotation shaft (30), and actuating means (4,5,6) that comprise an actuator (4) which is displaced when it is operated. Said displacement causes the lid (3) to pivot in relation to said rotation shaft (30) revealing said opening (11), being possible to provide the cigarettes (200) through said opening (11). When the actuator (4) is displaced in a longitudinal direction (X), said actuating means (4,5,6) are longitudinally displaced and draw a cigarette (200), such that said cigarette (200) is provided through said opening (11).

### TECHNICAL FIELD

The present invention is related to cigarette dispensers, and more specifically to cigarette dispensers designed to reduce tobacco consumption.

### PRIOR ART

Cigarette dispensers designed to reduce the consumption of tobacco are known. A dispenser of this type comprises a housing, a compartment inside said housing for storing cigarettes. Said housing comprises at least one opening for allowing the user to take a cigarette out of the compartment. Some of these devices comprise electronic means, whereby the time can be controlled between one cigarette leaving the compartment and the next one doing so, thereby helping the user to reduce their tobacco consumption.

U.S. Pat No. 5,566,855 discloses a dispenser of this type. The compartment comprises a rotary structure and a large number of slots arranged in said rotary structure, one cigarette fitting into each slot. The dispenser comprises a lid that pivots when it is operated by a user, providing access to one of said slots, whereby a cigarette may be taken out of said compartment. The electronic means cause said structure to rotate, said rotation being effected once a predetermined period of time has elapsed. Once said interval has elapsed, said electronic means cause said structure to rotate, thereby providing access to another slot in said compartment, whereupon another cigarette may be taken out of said compartment.

U.S. Pat. No. 5,203,472 discloses a dispenser that comprises a housing that surrounds a compartment where the cigarettes are stored, an opening made in said housing, and a belt with a large number of holes mounted between the compartment and the housing. When a hole in said belt coincides with the opening in the housing, it is possible to take a cigarette out of the compartment, through said hole and said opening. Once a cigarette has been taken out, the user has to operate a slide, such that when the user operates said slide said belt moves forward, a new hole coinciding with the opening.

JP2002051761 discloses a dispenser which comprises a lid that pivots to reveal an opening through which a cigarette is taken out, electronic means and a slide. The electronic means allow the lid to pivot only when a set period of time has elapsed since the previous time said opening was revealed, said lid pivoting when the user operates the slide.

### DISCLOSURE OF THE INVENTION

The object of the invention is to provide a cigarette dispenser, and more specifically a dispenser for helping a user to reduce or stop their consumption of tobacco.

The dispenser of the invention comprises a compartment where cigarettes are stored longitudinally, an opening through which the cigarettes facing said opening are dispensed, and a lid which covers the opening and which is connected to said dispenser by means of a rotating shaft, said lid pivoting in relation to said rotating shaft to reveal said opening and provide the cigarettes through said opening.

The dispenser furthermore comprises actuating means, said actuating means comprising an actuator which is longitudinally displaced when it is operated, said displacement causing the lid to pivot in relation to the rotating shaft, revealing the opening. The remaining actuating means are longitudinally displaced with said actuator, said longitudinal displacement drawing a cigarette, such that said cigarette is provided through said opening.

Thus, by means of a single operation, in addition to revealing the opening in order to provide cigarettes stored inside the dispenser, the operation of the actuator also draws a cigarette, providing said cigarette through said opening.

These and other advantages and specifications of the invention will be made clear in the light of the figures and of the detailed disclosure of the invention.

### DESCRIPTION OF THE FIGURES

FIG. 1 is a perspective view of an embodiment of the dispenser of the invention.

FIG. 2 shows the dispenser of FIG. 1, with cigarettes stored inside.

FIG. 3 shows the frame of the dispenser of FIG. 1.

FIG. 4 shows the lid of the dispenser of FIG. 1.

FIG. 5 shows the actuating means of the dispenser of FIG. 1.

FIG. 6 shows the rod and the frame of the dispenser of FIG. 1.

FIG. 7 shows the rod of FIG. 6, and the actuating means of FIG. 5.

FIG. 8 shows the base of the dispenser of FIG. 1.

FIG. 9 is a plant view of the dispenser of FIG. 1.

FIG. 10 shows the cigarettes disposed in the dispenser of FIG. 1.

FIG. 11 shows the actuating means of the dispenser of FIG. 1.

FIG. 12 shows the dispenser of FIG. 1, with the loader housed inside.

FIG. 13 is a side section view of the dispenser of FIG.1.

### DETAILED DISCLOSURE OF THE INVENTION

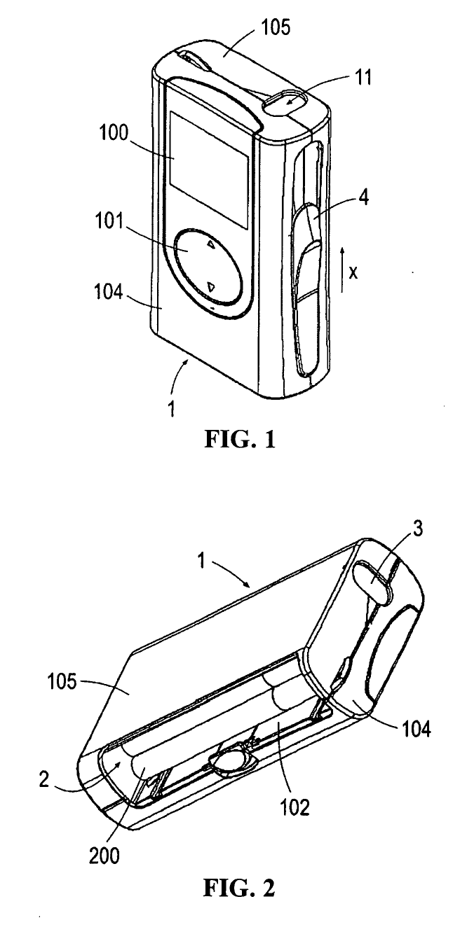

FIGS. 1 and 2 show an embodiment of the dispenser 1 of the invention, said dispenser helping a user to reduce or stop his/her consumption of tobacco, in a preferred embodiment. Dispenser 1 comprises a screen 100 that displays the different options available to the user, and a control panel 101 by means of which a user may access to the different options that appear on the screen 100. In the preferred embodiment, the user programmes a specific time so that a cigarette 200 is provided once said time has elapsed since the previous cigarette was provided.

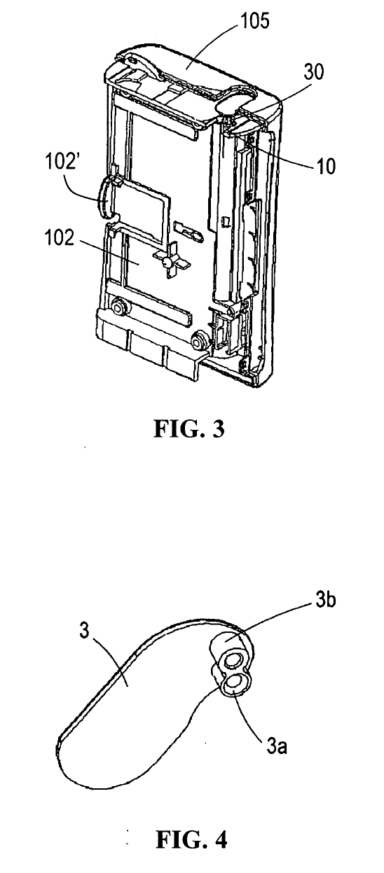

Dispenser 1 also comprises a cover 104, a base 105, a compartment 2 for storing cigarettes 200, disposed between said cover 104 and said base 105, and a frame 102 shown in FIG. 3. The frame 102 is disposed between said compartment 2, and the screen 100 and the control panel 101, said screen 100 and said control panel 101 being disposed on said frame 102. Thus, said compartment 2 is separated from said control panel 101 and said screen 100 by means of said frame 102.

The cigarettes 200 are provided through an opening 11, the cigarette 200 facing said opening 11 being provided. A lid 3 covers said opening 11 to avoid the cigarettes 200 being provided accidentally. With reference to the FIG. 4, the lid 3 comprises two hollow lugs 3a and 3b. A rotation shaft 30 disposed on the frame 102 is housed in the hollow lug 3a, said lid 3 being attached to said rotation shaft 30. The lid 3 pivots in relation to the rotation shaft 30 to reveal the opening 11, and so allows cigarettes 200 to be provided through said opening 11.

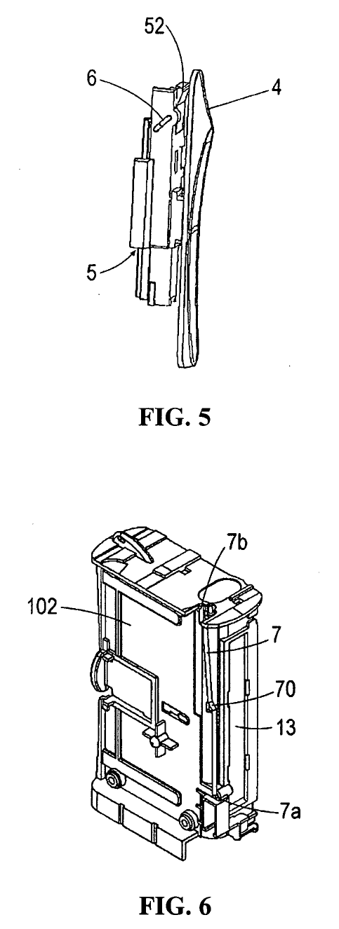

In order to provide a cigarette 200, the dispenser 1 comprises actuating means 4, 5 and 6 shown in FIG. 5, said actuating means 4, 5 and 6 comprising an actuator 4. The user operates the actuator 4, said actuator 4 being displaced longitudinally in a longitudinal direction X, the other actuating means 5 and 6 being displaced with said actuator 4 in said longitudinal direction X. The longitudinal displacement of said actuator 4 causes the lid 3 to pivot in relation to the rotation shaft 30, revealing the opening 11. At the same time, being longitudinally displaced, said actuating means 4, 5 and 6 draw a cigarette 200, in such a way that said cigarette 200 is provided through said opening 11.

The dispenser 1 comprises a rod 7 disposed longitudinally and shown in FIG. 6, which is attached by means of a first end 7a to the frame 102 and which can pivot in relation to said first end 7a, with the longitudinal displacement of the actuator 4 causing said rod 7 to pivot in relation to said first end 7a. A second end 7b of said rod 7 is housed in the hollow lug 3b of the lid 3, said rod 7 being attached to said lid 3. Thus, when said rod 7 pivots in relation to the first end 7a, said lid 3 pivots in relation to the rotation shaft 30 revealing the opening 11. In order for said lid 3 to pivot in relation to said rotation shaft 30, said rod 7 moves along the surface of a curved guiding lug 10 disposed in the frame 102. The rod 7 comprises a sloping section 70, in such a manner that with the longitudinal displacement of the actuator 4, the actuating means 4, 5 and 6 act upon said sloping section 70, causing said rod 7 to pivot in relation to said first end 7a.

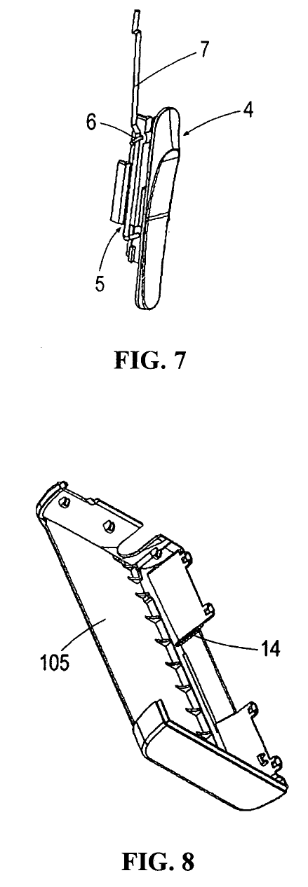

The actuating means 4, 5 and 6 comprise a slide 5 attached to the actuator 4 and which is displaced longitudinally with said actuator 4 along a groove 13 provided on one side of the frame 102, and a substantially U-shaped bridge piece 6 attached to said slide 5. As shown in FIG. 7, the rod 7 is disposed between the slide 5 and the bridge piece 6, so with the longitudinal displacement of said actuator 4, said bridge piece 6 pushes the sloping section 70 of said rod 7 causing said rod 7 to pivot in relation to the first end 7a. Said bridge piece 6 is attached to said slide 5 obliquely, thereby facilitating said rod 7 to pivot. Said slide 5 returns to its original position by means of a spring (not shown in the figures), the actuator 4 returning with said slide 5. Said slide 5 is attached by one of its ends to the slide 5, and attached to the frame 102 by the other end.

The dispenser 1 comprises a lug 14 shown in FIG. 8, and the actuating means 4, 5 and 6 comprise a flexible tab 52 disposed on the slide 5 and shown in FIG. 5. Thus, when said actuating means 4, 5 and 6 are longitudinally displaced, said flexible tab 52 makes contact with the lug 14, making the longitudinal displacement of said actuating means 4, 5 and 6 difficult. In order for said actuating means 4, 5 and 6 to continue their displacement, this displacement has to be forced by operating the actuator 4, the bending of said flexible tab 52, as it is flexible, overcoming said lug 14. If said actuator 4 is not operated, the necessary force is not provided to bend said flexible tab 52, preventing a cigarette 200 from being provided accidentally.

The actuating means 4, 5 and 6 also comprise a support surface 51 facing the compartment 2, and disposed on the slide 5, in such a way that when a cigarette 200 is resting against said support surface 51, said cigarette 200 faces the opening 11. As shown in FIG. 2, in the preferred embodiment, the cigarettes 200 are stored in compartment 2 in two rows so that the cigarettes 200 are arranged alternatively resting against the support surface 51, the actuating means 4, 5 and 6 drawing a cigarette 200 from one or other row alternatively.

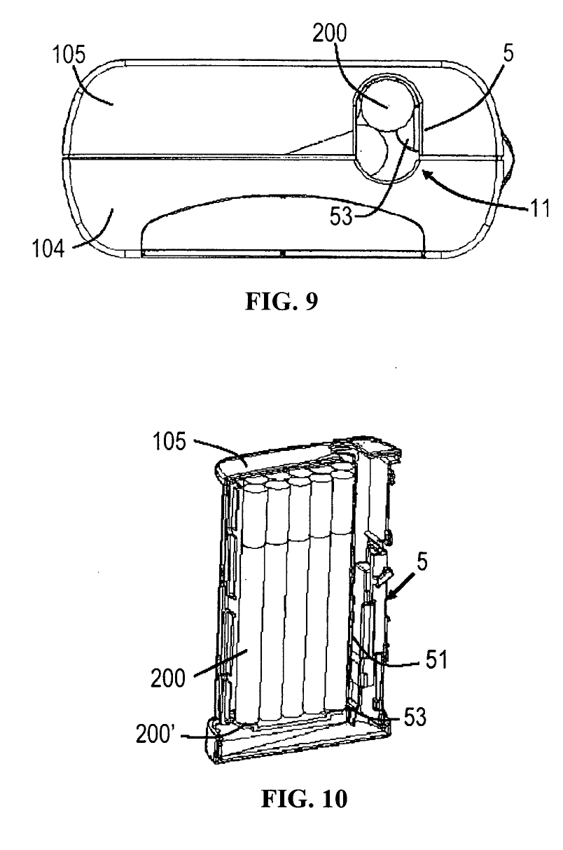

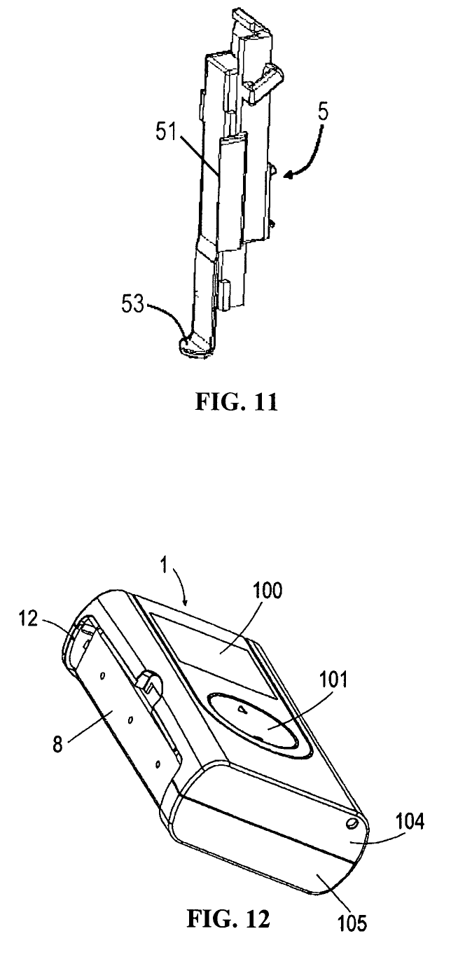

With reference to FIGS. 9 to 11, actuating means 4, 5 and 6 comprise a base 53 perpendicular to a support surface 51, and which is preferably substantially curve shaped. Said support surface 51 and said base 53 forming a “L” shaped profile. When a cigarette 200 rests against said support surface 51, an end 200′ of said cigarette 200 is disposed above said base 53, such that when said actuating means 4, 5 and 6 are operated, said base 53 pushes said cigarette 200, said cigarette 200 being provided through the opening 11.

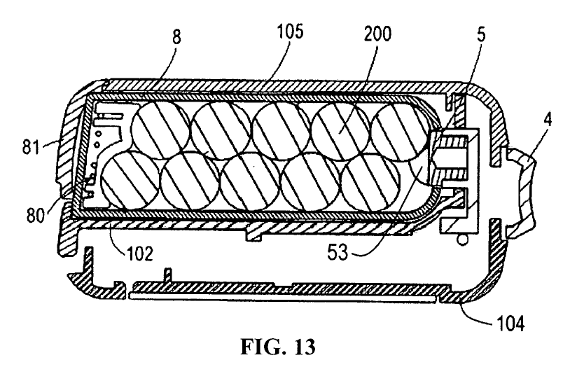

With reference to FIG. 12, the dispenser 1 of the invention comprises a loader 8 that is housed in the compartment 2, the cigarettes 200 being arranged in said loader 8. Said loader 1 comprises a side opening 12, with said loader 8 being inserted into or removed from said compartment 2 through said side opening 12. Once said loader 8 is housed in said compartment 2, a loader lid 81 shown in FIG. 13 covers said side opening 12. The frame 102 comprises a tab 102′ by means of which the loader 8 is housed in the compartment 2, with the operation of said tab 102′ being required to remove said loader 8 from said compartment 2.

Loader 8 comprises a spring 80 which acts upon the cigarettes 200 that are arranged in said loader 8. Thus, when the loader 8 is housed in the compartment 2, said spring 80 causes one of said cigarettes 200 to rest against the support surface 51 on the slide 5, said cigarette 200 facing the opening 11. When said cigarette 200 is provided through said opening 11, said spring 80 causes another cigarette 200 to rest against said support surface 51, said cigarette facing said opening 11.

What is claimed is:

1. Cigarette dispenser that comprises:
a compartment (2) for storing cigarettes (200);
an opening (11) through which the cigarettes (200) facing said opening (11) are provided;
a lid (3) which covers the opening (11) and which is attached to the dispenser (1) by means of a rotation shaft (30), said lid (3) pivoting in relation to said rotation shaft (30) to reveal said opening (11) and to provide the cigarettes (200) through said opening (11); and
actuating means (4,5,6) that comprise an actuator (4) which is displaced in a longitudinal direction (X) when it is operated, said displacement causing the lid (3) to pivot in relation to the rotation shaft (30) revealing the opening (11), all the other actuating means (5,6) being displaced with said actuator (4), and said actuating means (4,5,6) drawing a cigarette (200) when they are longitudinally displaced, such that said cigarette (200) is provided through said opening (11).

2. Dispenser according to claim 1, which comprises a rod (7) longitudinally disposed and attached by a first end (7a), said rod (7) being able to pivot in relation to said first end (7a), and said rod (7) being attached to the lid (3) by means of a second end (7b), such that the longitudinal displacement of the actuator (4) causes said rod (7) to pivot in relation to said first end (7a), causing the lid (3) to pivot in relation to the rotation shaft (30).

3. Dispenser according to claim 2, wherein the rod (7) comprises a sloping section (70), such that with the longitudinal displacement of the actuator (4), the actuating means (4,5,6) act upon said sloping section (70) causing said rod (7) to pivot in relation to the first end (7a).

4. Dispenser according to claim 3, wherein the actuating means (4,5,6) comprise a slide (5) attached to the actuator (4) and which is longitudinally displaced with said actuator (4), and a substantially U-shaped bridge piece (6) attached to said slide (5), the rod (7) being disposed between said slide (5) and said bridge piece (6), such that with the longitudinal displacement of said actuator (4), said bridge piece (6) is longitudinally displaced pushing the sloping section (70) on said rod (7), causing said rod (7) to pivot in relation to the first end (7a).

5. Dispenser according to claim 4, wherein the bridge piece (6) is attached to the slide (5) obliquely.

6. Dispenser according to claim 2, which comprises a curved guiding lug (10), such that when the rod (7) pivots in relation to the first end (7a), said rod (7) is displaced along the surface of said curved lug (10), causing the lid (3) to pivot in relation to the rotation shaft (30).

7. Dispenser according to claim 1, which comprises a lug (14) and the actuating means (4,5,6) comprise a flexible tab (52), such that when said actuating means (4,5,6) are longitudinally displaced in a longitudinal direction (X), said flexible tab (52) cooperates with the lug (14) making the longitudinal displacement of said actuating means (4,5,6) difficult.

8. Dispenser according to claim 1, wherein the actuating means (4,5,6) comprise a support surface (51) facing the compartment (2) such that said actuating means (4,5,6) draw the cigarette (200) resting against said support surface (51).

9. Dispenser according to claim 8, wherein the cigarettes (200) are stored in the compartment (2) in two rows, such that the cigarettes (200) of one or other row rest alternatively against the support surface (51) of the actuating means (4,5,6), said actuating means (4,5,6) drawing a cigarette (200) from one or other row alternatively.

10. Device according to claim 9, wherein actuating means (4,5,6) comprise a base (53) perpendicular to a support surface (51), said support surface (51) and said base (53) forming a substantially “L” shaped profile, and an end (200′) of the cigarette (200) which rests on said support surface (51) leading on said base (53), in such a way that when said actuating means (4,5,6) are actuated, said base (53) pushes against said cigarette (200), said cigarette (200) being supplied through the opening (11).

11. Device according to claim 10, wherein the base (53) is substantially curve shaped.

12. Dispenser according to claim 1, which comprises a loader (8) in which the cigarettes (200) are disposed and a side opening (12), the loader (8) being housed in the compartment (2) by means of said side opening (12).

13. Dispenser according to claim 12, wherein the loader (8) comprises a spring (80) on one of its sides, such that when a cigarette (200) is provided through the opening (11), said spring pushes the cigarettes (200) arranged in said loader (8), a new cigarette (200) resting against the support surface (51).
